(19) United States
(12) Patent Application Publication
(10) Pub. No.: US 2007/0104047 A1
(43) Pub. Date: May 10, 2007

(54) Optical disc drive and focus control method thereof

(75) Inventor: Tzu-Nan Chen, Taipei (TW)

Correspondence Address: BIRCH STEWART KOLASCH & BIRCH, PO BOX 747, FALLS CHURCH, VA, 22040-0747, US

(73) Assignee: Lite-On it Corporation

(21) Appl. No.: 11/594,819

(22) Filed: Nov. 9, 2006

(30) Foreign Application Priority Data
Nov. 10, 2005 (TW) 94139501

(51) Int. Cl. G11B 7/00

(52) U.S. Cl. 369/44.25; 369/53.28

(57) ABSTRACT

An optical disc drive and a focus control method thereof. If a summation signal exceeds a threshold value, an object lens of the optical disc drive is moved towards the optical disc for a first distance from an original position and then away from the optical disc for the first distance, and then is focused on the optical disc correctly according to an S-curve of a focus error signal. If not, the object lens is moved away from the optical disc for a second distance, and whether an S-curve is generated according to the focus error signal is determined. If so, the object lens is focused on the optical disc correctly. Otherwise, the object lens is moved to the original position and then towards the optical disc for a third distance, and then is focused on the optical disc correctly according to an S-curve of the focus error signal.

This application claims the benefit of Taiwan application Serial No. 94139501, filed Nov. 10, 2005, the subject matter of which is incorporated herein by reference.

### BACKGROUND OF THE INVENTION

1. Field of the Invention

The invention relates in general to an optical disc drive and a focus control method therefor, and more particularly to an optical disc drive that can prevent its object lens from crashing the optical disc and to a focus control method therefor.

2. Description of the Related Art

In an optical disc drive, an optical pickup head focuses a light beam via an object lens on a rotating optical disc, and receives a reflected light from the optical disc by using a light detector. However, in addition to normal disc rotation, the optical disc in rotation has abnormal movement such as disc vibration and eccentric rotation, where the disc vibration may lead to focusing errors. Thus, a prerequisite for performing read and write operations on the optical disc is to obtain a signal indicating focus error according to which the position of the optical disc can be adjusted.

It is desirable to develop new optical data storage media for the next generation to store much more data in order to achieve high-density storage in a single medium. This goal can be achieved by making the light spot smaller through a laser beam of a reduced wavelength for accessing data or an object lens with a larger numerical aperture (NA). However, a larger NA will reduce the working distance (WD) measured between the object lens and the optical disc.

When the working distance WD is reduced, the object lens might crash the optical disc, resulting in permanent damage to the object lens or the optical disc. Manufacturing error of the actuator or inappropriate servo control may cause this undesired situation when the object lens moves upwards or downwards to perform focus servo control. It is appreciated that a more accurate method for focus control should be provided as high-density optical storage media is developing.

### SUMMARY OF THE INVENTION

It is therefore an object of the invention to provide an optical disc drive and a focus control method such that the object lens focuses on the optical disc correctly and crash of the object lens and optical disc will be prevented.

According to an embodiment of the invention, a focus control method is provided for use in an optical disc drive, wherein the optical disc drive includes an optical pickup head to access an optical disc, and the optical pickup head includes an object lens. The method includes the following steps. First, a light beam is emitted to the optical disc and a corresponding reflected light beam is then received to generate a summation signal and a focus error signal, wherein the object lens is located at an original position. Next, it is determined whether the summation signal is greater than a threshold value. If the summation signal is greater than a threshold value, the object lens is moved towards the optical disc for a first distance from the original position and away from the optical disc for the first distance from the original position. In addition, the object lens is focused on the optical disc correctly according to an S-curve of the focus error signal. If the summation signal is not greater than the threshold value, the object lens is moved away from the optical disc for a second distance, and then it is determined whether an S-curve is generated according to the focus error signal. If so, the object lens is focused on the optical disc correctly. Otherwise, the object lens is moved to the original position and then towards the optical disc for a third distance, and the object lens is focused on the optical disc correctly according to an S-curve of the focus error signal.

According to another embodiment of the invention, an optical disc drive is provided for accessing an optical disc. The optical disc drive includes an optical pickup head and a controller. The optical pickup head includes an object lens. The object lens is located at an original position. The optical pickup head is used for emitting a light beam to the optical disc and receiving a corresponding reflected light beam to generate a summation signal and a focus error signal. The controller is used for determining whether the summation signal is greater than a threshold value, wherein the controller controls the object lens to move towards and away from the optical for a first distance from the original position, and to focus the object lens on the optical disc correctly according to an S-curve of the focus error signal if the summation signal is greater than a threshold value. If the summation signal is not greater than the threshold value, the controller controls the object lens to move away from the optical disc for a second distance. If an S-curve is generated according to the focus error signal, the controller controls the object lens to focus on the optical disc correctly. If no S-curve is generated according to the focus error signal, the controller controls the object lens to move to the original position and then towards the optical disc for a third distance, and controls the object lens to focus on the optical disc correctly according to an S-curve of the focus error signal.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIGS. 1A-1C illustrate detection of light.

FIG. 1D shows the relationship between an error focus signal FE and a working distance.

FIG. 2 illustrates the working distance.

FIG. 3 illustrates the relative position of the object lens and the optical disc according to an embodiment of the invention.

FIG. 4 shows a flowchart illustrating a method for focus control according to a preferred embodiment of the invention.

FIG. 5A illustrates the situation when the distance x is in a first state.

FIGS. 5B and 5C illustrate the situation when distance x is in a third state.

FIG. 5D illustrates the situation when the distance x is in a fourth state.

FIG. 6 shows an optical disc drive according to a preferred embodiment of the invention.

### DETAILED DESCRIPTION OF THE INVENTION

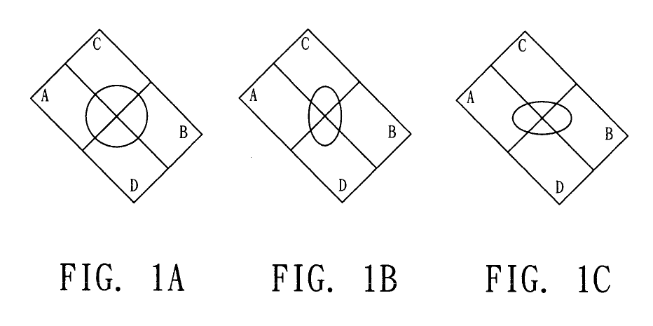

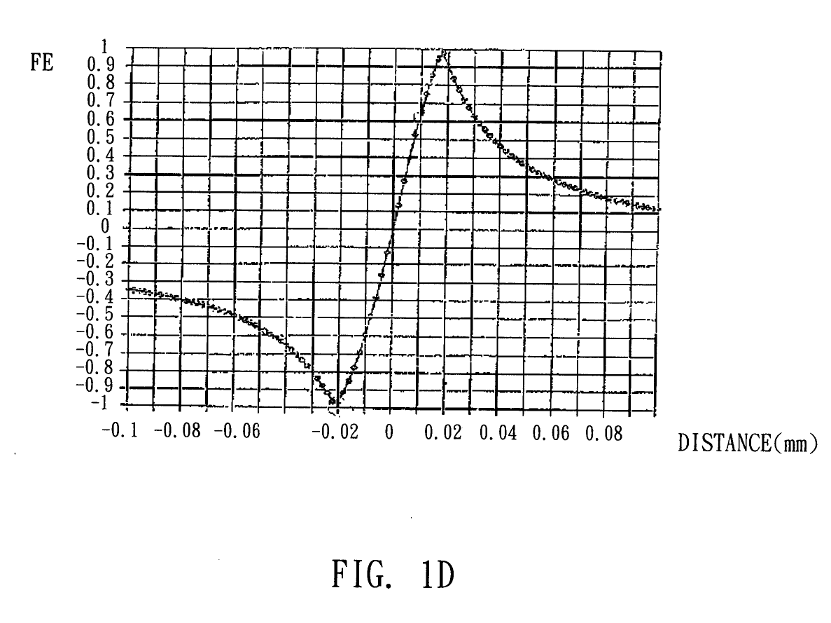

Referring to FIGS. 1A, 1B, and 1C, a photo-detector module of an optical pickup head is illustrated. The photo-detector module includes four split photo-detectors A, B, C, and D. When the optical disc is located at different positions before or after the focus, the light spot correspondingly forms different shapes on the four split photo-detectors and the split photo-detectors receives the light beam and generate signals VA, VB, VC, and VD, respectively. A focus error signal FE can then be obtained by signal processing of these signals generated by the split photo-detectors. The value of the focus error signal can be determined by:
FE=(VA+VB)−(VC+VD).

As illustrated in FIG. 1A, the light spot forms a circle on the photo-detector module when the object lens focuses on the optical disc correctly. In this case, the value of the focus error signal is zero. As shown in FIG. 1B, the light spot forms an ellipse on the photo-detector module when the object lens locates too close to the optical disc. The value of the focus error signal in this case is less than zero. Referring to FIG. 1C, the light beam also forms an ellipse on the photo-detector module when the object lens is located too far from the optical disc. The value of the focus error signal in this case is greater than zero.

Referring to FIG. 1D, a graph illustrates the relationship of the values of the focus error signal and the working distance, wherein a curve similar to the letter “S” is shown, called an S-curve. In FIG. 1D, it is assumed that the distance is defined as zero when a state as indicated in FIG. 1A occurs; that is, the focus is correct. For a state as indicated in FIG. 1B, the distance ranges between −0.1 mm to 0 mm. For a state as indicated in FIG. 1C, the distance ranges between +0.1 mm to 0 mm. In a state where the distance is greater than +0.1 mm or less than −0.1 mm, the value of the focus error signal FE tends to about zero.

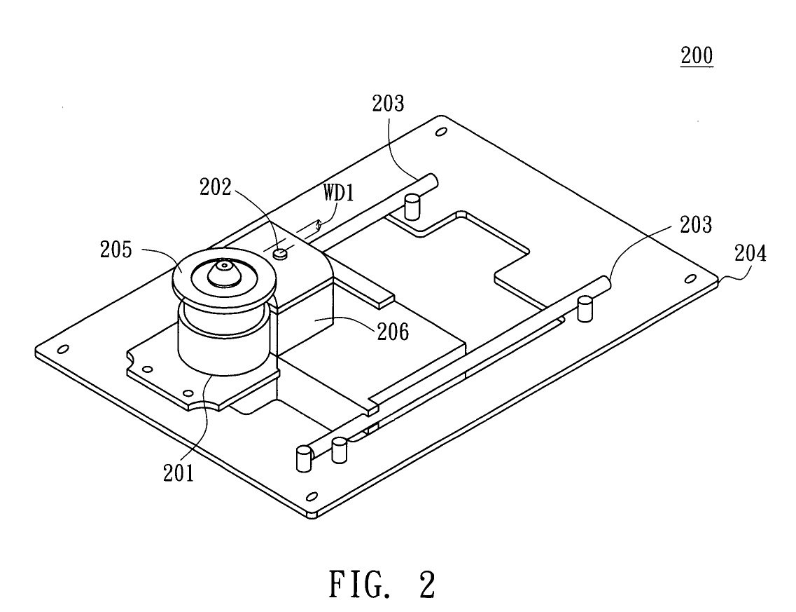

Referring to FIG. 2, the working distance is illustrated in an optical disc drive. The optical disc drive 200 includes a turntable 205, a spindle motor 201, an optical pickup head 206, a guided rod 203, and a board 204. The optical pickup head 206 includes an object lens 202. The turntable 205 supports the optical disc while the spindle motor 201 rotates the optical disc. The optical pickup head 206 emits a light beam to the optical disc and receives the reflected beam, through the object lens 202. The optical pickup head 206 accesses the optical disc for data by way of the movement of the guided rod 203. All of the parts described above are configured on the board 204.

When the optical disc is accessed, the distance between the object lens 202 and the optical disc, that is, the distance at which the object lens 202 focuses on the optical disc correctly, is defined as the working distance (WD). In FIG. 2, the perpendicular distance (WD1) between the object lens 202 and the upper surface of the turntable 205, as the optical disc is actually accessed, is required to reach a suitable state to enable the object lens 202 to focus on the optical disc correctly.

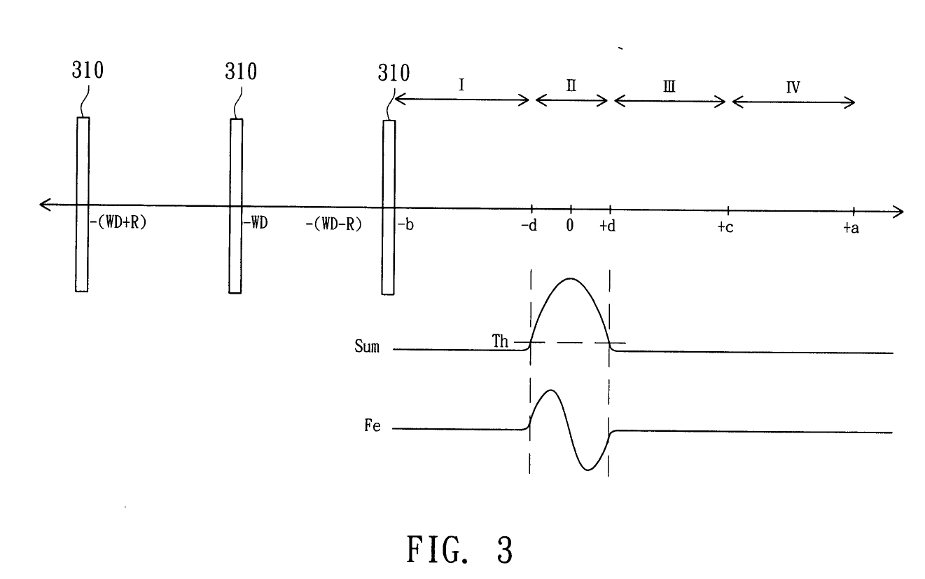

Referring to FIG. 3, the relative positions between the object lens and the optical disc are illustrated according to the invention. Since the optical disc 310 may vibrate while the optical disc 310 is accessed, the distance R is defined to indicate a reasonable range of vibration. When the object lens 202 focuses on the optical disc 310 correctly, the distance between the object lens 202 and optical disc 310 is the WD, that is, the distance measured along with the horizontal axis from 0 to −WD. If the optical disc 310 is located at the coordinate of −WD, measured along with the horizontal axis from zero, the optical disc 310 vibrates in a range of coordinates between −(WD+R) to −(WD−R).

The movement of the object lens 202, measured along with the horizontal axis, as indicated in FIG. 3, can be divided into ranges I, II, III, and IV. The coordinates of the range I on the horizontal axis are between −b to −d. The coordinates of the range II on the horizontal axis are between +d to −d. The coordinates of the range III on the horizontal axis are between +d to +c. The coordinates of the range IV on the horizontal axis are between +c to +a.

The perpendicular distance between the object lens 202 and optical disc 310 is designated as x. As above discussed, when the object lens 202 is in the range I, the range of the distance x is expressed by: WD−(R+b)≦x≦WD+(R−d).

When the object lens 202 is in the range II, the range of the distance x is expressed by: WD−(R+b)≦x≦WD+(R+d).

When the object lens 202 is in the range Ill, the range of the distance x is expressed by: WD−(R−d)≦x≦WD+(R+c).

When the object lens 202 is in the range IV, the range of the distance x is expressed by: WD−(R−c)≦x≦WD+(R+a).

According to the above four ranges of x and the possible range of movement of the optical disc 310, the value of the distance x between the object lens 202 and optical disc 310 may fall into four ranges indicating four different states of the object lens 202 as follows.

In a first state where x<WD−d, the distance x between the object lens 202 and optical disc 310 is not enough for focusing and the object lens 202 needs to move far from the optical disc 310.

In a second state where WD−d<x<WD+d, the distance x between the object lens 202 and optical disc 310 is close to an ideal working distance WD, and the object lens 202 will focus on the optical disc 310 correctly if the object lens 202 moves within a specific range.

In a third state where WD+d<x<WD+(R+c), the distance x between the object lens 202 and optical disc 310 is far away from the ideal working distance WD. Making the object lens 202 close to the optical disc 310 will smooth the way for correct focusing.

In a fourth state where WD+(R+c)<x<WD+(R+a), the distance x between the object lens 202 and optical disc 310 is larger than that in the third state. As compared to the third state, the object lens 202 needs to move closer to the optical disc 310 in order to smooth the way for correct focusing.

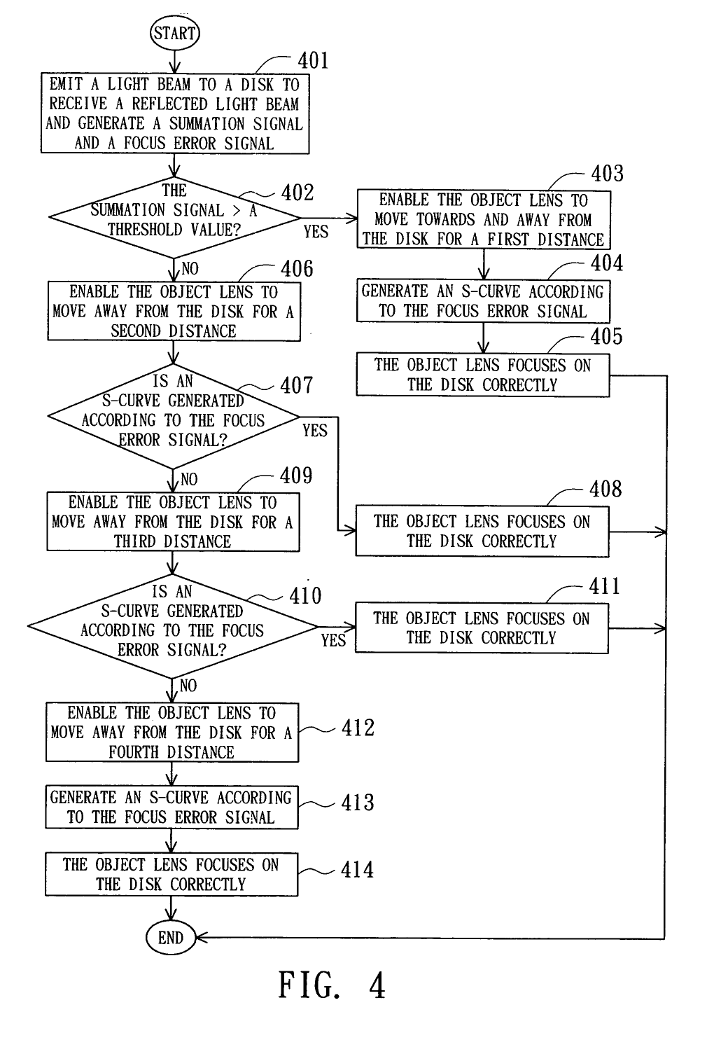

Referring to FIG. 4, a focus control method in accordance with a preferred embodiment of the invention is shown in block diagram form. First, as indicated in step 401, the optical pickup head 206 is enabled to emit a light beam to the optical disc 310 via the object lens 202 and receive a reflected light beam from the optical disc 310 so as to generate a summation signal, denoted by “SUM”, and a focus error signal, denoted by “FE”. The object lens 202 is located at an original position. The summation signal, i.e. SUM, is defined by:
SUM=(VA+VB+VC+VD).

Next, in step 402, a determination is made as to whether the summation signal SUM is greater than a threshold value Th. If so, it is determined that the distance x indicates the second state, where WD−d<x<WD+d, and then step 403 is performed to enable the object lens 202 to move, from the original position, towards and away from the optical disc 310 for a first distance, for example, WD/2 or 2 d. In step 404, the focus error signal FE is detected and the S-curve is generated accordingly. As in step 405, after the object lens 202 focuses on the optical disc 310 correctly by determination with the S-curve, the method ends.

In step 402, if the summation signal SUM is not greater than the threshold Th, step 406 is performed to move the object lens 202 away from the optical disc 310 for a second distance, where it is supposed that the distance x indicates the first state, i.e. x<WD−d, and the second distance is, for example, equal to k1(WD+d). Next, as indicated in step 407, a determination is made as to whether an S-curve is generated according to the focus error signal FE. If so, step 408 is performed to make the object lens 202 focus on the optical disc 310 correctly according to the S-curve.

In step 407, if it is determined that no S-curve is generated according to the focus error signal FE in step 406, it shows that the distance x neither indicates the first state nor the second state. Step 409 is then performed where the object lens 202 is moved to a third distance close to the optical disc 310 after returning to its original position. In this case, it is supposed that the distance x indicates the third state where WD+d<x<WD+(R+c), and the third distance is, for example, equal to k2(R+c+d).

Next, as shown in step 410, it is determined whether an S-curve is generated according to the focus error signal FE in step 409. If so, according to the S-curve, the object lens 202 is enabled to focus on the optical disc 310 correctly. The method then ends.

In step 410, if it is determined that no S-curve is generated according to the focus error signal FE in step 409, the method proceeds to step 412. In step 412, the object lens 202 is moved to be close to the optical disc 310 for a fourth distance after returning to its original position. In this case, it is supposed that the distance x indicates the fourth state where WD+(R+c)<x<WD+(R+a), and the fourth distance is, for example, equal to k3(R+a+d). After that, an S-curve is generated according to the focus error signal FE, as indicated by step 413. After the object lens 202 correctly focuses on the optical disc 310 according to the S-curve, as shown by step 414, the method ends.

In step 403, since the distance x indicates the second state, the object lens 202 needs to move close to or far away from the optical disc 310 for at least a distance d in order to make the distance x be the working distance WD. In this way, the object lens 202 can correctly focuses on the optical disc 310. Thus, in addition to WD/2 or 2 d, the first distance can be a value leading to the generation of an S-curve and prevention of crash involving the object lens 202 and optical disc 310.

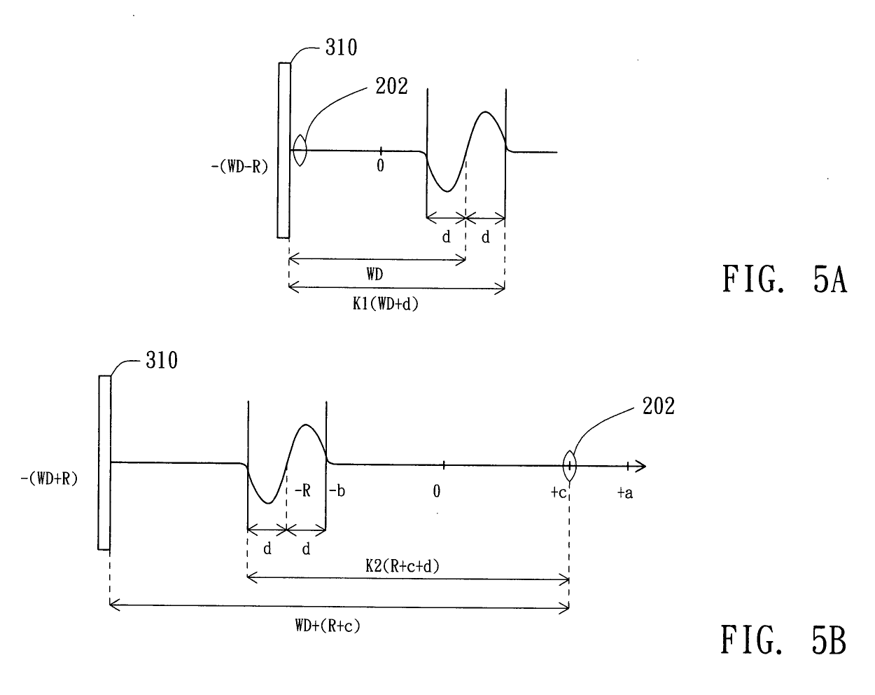

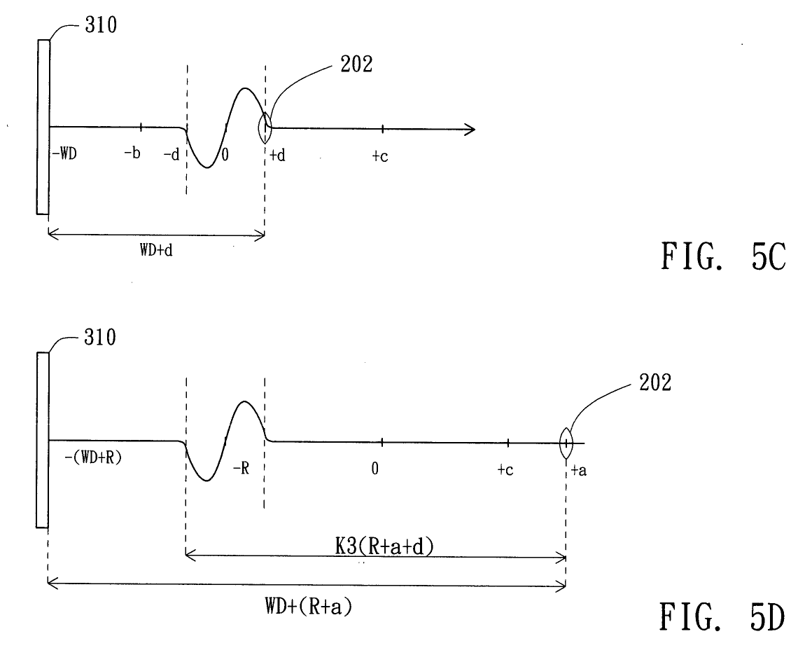

Referring to FIG. 5A, the distance x indicates the first state, wherein the distance x in this example indicates the worst case that would occur in the first state, that is, the object lens 202 probably crashing the optical disc 310. In step 406, the object lens 202 needs to move away from the optical disc 310 for at most a distance of WD+d in order to generate an S-curve. However, since the actuator that moves the object lens 202 may cause errors or has a specification error, it requires that the actuator drives the object lens 202 according to a distance of (WD+d) times a parameter k1 in order to move the object lens 202 far away from the optical disc 310 for a distance of WD+d. As an example, the parameter k1 is usually taken as about 1.3, which can also be adjusted depending on the error.

Referring to FIGS. 5B and 5C, the distance x indicates the third state, wherein the distance x in this example is the maximum value in the third state. When the distance x equals to WD+(R+c), the optical disc 310 is located at the coordinate of −(WD+R) and the object lens 202 is located at the coordinate of +c. In this case, the coordinate to which the object lens 202 is moved can lead the object lens 202 to focus correctly on the optical disc 310 is −R. In step 409, in order to obtain an S-curve, the object lens 202 needs to be moved close to the optical disc 310 for the third distance k2(R+c+d). The parameter k2 is required for the similar reason to that for the parameter k1. This reason will no longer repeated here for the sake of brevity.

FIG. 5C illustrates an example where the distance x is the minimum value in the third state, wherein the distance x is equal to WD+d. In order to prevent the object lens 202 from crashing the optical disc 310 as approaching the position for the third distance, the following condition should be fulfilled:
k2(R+c+d)<WD+d.
It follows that:
c<(WD+d)/k2−(R+d).
According to this inequality, a range of the distance c can be determined for use in setting the value of distance c.

Referring to FIG. 5D, the distance x indicates the maximum value in the fourth state, as an example. In FIG. 5D, the optical disc 310 is located at the coordinate of −(WD+R) and the object lens 202 is located at the coordinate of +a. In this case, the object lens 202 can focus on the optical disc 310 correctly when being moved to the coordinate of −R. In step 412, the object lens 202 is moved close to the optical disc 310 for the fourth distance so as to generate an S-curve. The fourth distance has to be equal to k3(R+a+d). The parameter k3 is required for the similar reason to that for the parameter k1. This reason will no longer repeated here for the sake of brevity.

In the fourth state, the fourth distance has to be less than the possible minimum value of the distance x in the fourth state in order to prevent the object lens 202 from crashing the optical disc 310, so that:
k3(R+a+d)<WD+c+R.
It follows that:
a<(WD+c+R)/k3−(R+d).
According to this inequality, a range of the distance a can be determined for use in setting the value of distance a.

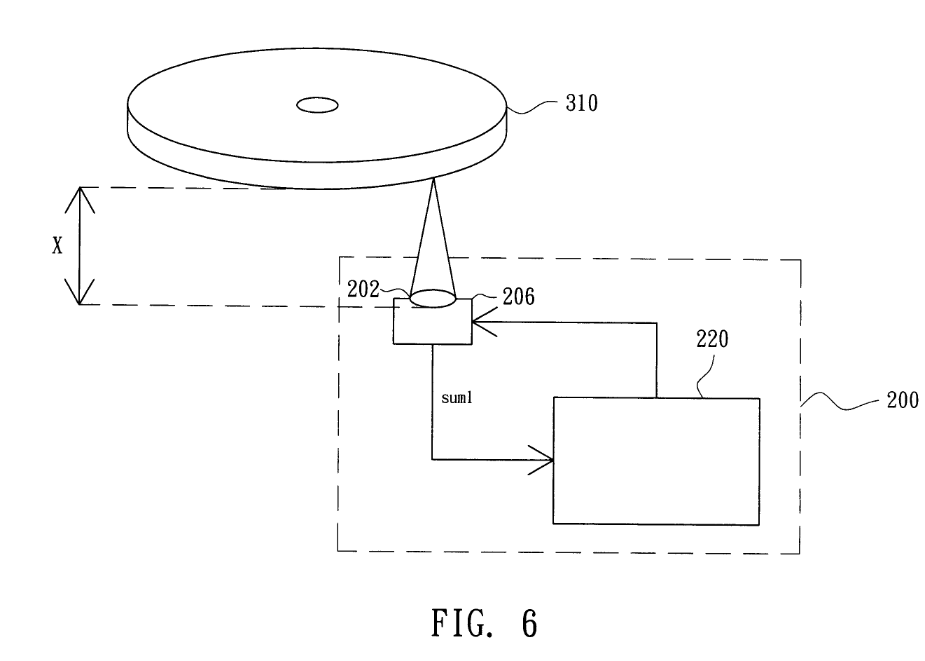

Referring to FIG. 6, an optical disc drive is illustrated according to a preferred embodiment of the invention. The optical disc drive 200 is used for accessing the optical disc 310. The optical disc drive 200 includes an optical pickup head 206 and a controller 220. The optical pickup head 206 includes an object lens 202. The optical disc 310 is a blu-ray disc (BD), for example. The controller 220 drives the optical pickup head 206 according to the summation signal SUM1 and the focus error signal FE, in order to change the perpendicular distance between the object lens 202 and optical disc 310. The optical disc drive 200 applies a focus control method, as described in FIG. 4.

The above description discloses an optical disc drive and a focus control method thereof according to the embodiments of the invention. Accordingly, in a high-density optical storage medium where a reduced working distance is required, the object lens not only can focus correctly and accurately on the storage medium, but also prevent the object lens from crashing the storage medium. Permanent damage to the object lens or the storage medium will be avoided therefore.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for focus control in an optical disc drive, the optical disc drive comprising an optical pickup head to access an optical disc, the optical pickup head comprising an object lens, the method comprising:
emitting a light beam to the optical disc and receiving a corresponding reflected light beam to generate a summation signal and a focus error signal, wherein the object lens is located at an original position;
determining whether the summation signal is greater than a threshold value;
if the summation signal is greater than a threshold value:
moving the object lens towards the optical disc for a first distance from the original position and away from the optical disc for the first distance from the original position; and
focusing the object lens on the optical disc correctly according to an S-curve of the focus error signal;
if the summation signal is not greater than the threshold value:
moving the object lens away from the optical disc for a second distance;
determining whether an S-curve is generated according to the focus error signal;
if so, focusing the object lens on the optical disc correctly; and
if not, moving the object lens to the original position and then towards the optical disc for a third distance, and focusing the object lens on the optical disc correctly according to an S-curve of the focus error signal.

2. The method according to claim 1, wherein in the step of moving the object lens towards the optical disc for a third distance, if no S-curve is generated according to the focus error signal, the method further comprises:
moving the object lens to the original position;
moving the object lens towards the optical disc for a fourth distance; and
focusing the object lens on the optical disc correctly according to the S-curve of the focus error signal.

3. The method according to claim 2, wherein the fourth distance is greater than the third distance.

4. The method according to claim 1, wherein the optical disc is a blu-ray disc (BD).

5. An optical disc drive for accessing an optical disc, the optical disc drive comprising:
an optical pickup head comprising an object lens, the object lens located at an original position, the optical pickup head being for emitting a light beam to the optical disc and receiving a corresponding reflected light beam to generate a summation signal and a focus error signal;
a controller for determining whether the summation signal is greater than a threshold value, wherein the controller controls the object lens to move towards and away from the optical for a first distance from the original position, and to focus the object lens on the optical disc correctly according to an S-curve of the focus error signal if the summation signal is greater than a threshold value;
wherein if the summation signal is not greater than the threshold value, the controller controls the object lens to move away from the optical disc for a second distance; if an S-curve is generated according to the focus error signal, the controller controls the object lens to focus on the optical disc correctly; if no S-curve is generated according to the focus error signal, the controller controls the object lens to move to the original position and then towards the optical disc for a third distance, and controls the object lens to focus on the optical disc correctly according to an S-curve of the focus error signal.

6. The optical disc drive according to claim 5, wherein when the object lens is moved towards the optical disc for the third distance, if no S-curve is generated according to the focus error signal, the controller controls the object lens to move to the original position and towards the optical disc for a fourth distance from the original position, and controls the object lens to focus on the optical disc correctly according to an S-curve of the focus error signal.

7. The optical disc drive according to claim 6, wherein the fourth distance is greater than the third distance.

8. The optical disc drive according to claim 5, wherein the optical disc is a blu-ray disc.
